(19) United States
(12) Patent Application Publication
(10) Pub. No.: US 2003/0149977 A1
(43) Pub. Date: Aug. 7, 2003

(54) Transferring large bitmap data using analog switching

(76) Inventor: Seema Kataria, San Diego, CA (US)

Correspondence Address: MILLER PATENT SERVICES, 2500 DOCKERY LANE, RALEIGH, NC, 27606, US

(21) Appl. No.: 10/067,036

(22) Filed: Feb. 4, 2002

(51) Int. Cl. G06F 3/00; H04N 5/445; G06F 13/00; H04N 7/12; H04N 11/02; H04N 11/04

(52) U.S. Cl. 725/37; 348/425.3; 725/39

(57) ABSTRACT

A method and apparatus for enhancing the performance in displaying a large bitmap image transferred from a producer device to a consumer device. When using EIA775A to transfer large bitmap images from a producer device to a consumer device performance can suffer. This is especially the case for very large images such as program guides and graphical user interfaces. Performance can be enhanced by determining if the bitmap image is larger than a predetermined threshold. If so, an audio/video control message can be sent from the producer device to the consumer device to switch from a digital connection to an analog connection. The large bitmap image can then be transferred as an analog signal rather than digital to enhance performance.

### FIELD OF THE INVENTION

This invention relates generally to the field of transfer of video images between video components. More particularly, the present invention relates to a method and apparatus for transferring large bitmap images between video devices by using an analog signal path rather than digital.

### BACKGROUND OF THE INVENTION

EIA775A is a protocol that defines the parameters for transferring data from a so-called “producer” device to a so-called “consumer” device. An example of a producer device might be a television set-top box or personal video recorder (PVR). An example of a consumer device might be a digital television set. This protocol is essentially overlaid on an IEEE 1394 communication bus to permit the producer device to send information to the consumer device. EIA775A protocol provides a method to transmit OSD (On Screen Data) information via an “asynchronous push” connection on an IEEE 1394 link.

### SUMMARY OF THE INVENTION

The present invention relates generally to communication between a producer device and a consumer device. Objects, advantages and features of the invention will become apparent to those skilled in the art upon consideration of the following detailed description of the invention.

In one embodiment consistent with certain embodiments of the present invention a method and apparatus is provided for enhancing the performance in displaying a large bitmap image transferred from a producer device to a consumer device. When using EIA775A to transfer large bitmap images from a producer device to a consumer device, performance can suffer. This is especially the case for very large images such as program guides and graphical user interfaces. Performance can be enhanced by determining if the bitmap image is larger than a predetermined threshold. If so, an audio/video control message can be sent from the producer device to the consumer device to switch from a digital connection to an analog connection. The large bitmap image can then be transferred as an analog signal rather than digital to advantageously enhance performance.

A method, consistent with certain embodiments of the present invention, of transmitting images from a producer device to a consumer device, comprises at the producer device: determining that a digital bitmap image is larger in size than a threshold; converting the digital bitmap image to an analog image; and sending the analog image to the consumer device.

Another method, consistent with certain embodiments of the present invention, of transmitting images from a producer device to a consumer device, comprises at the producer device: determining if a digital bitmap image is larger in size than a threshold and if the digital bitmap image is larger is size than the threshold: converting the digital bitmap image to an analog image; sending a control message as an audio video control (AVC) command to the consumer device to switch from a digital input to an analog input to receive the analog image; sending the analog image to the consumer device; and if the digital bitmap image is not larger is size than the threshold: sending the digital images using EIA775a protocol over an IEEE 1394 isochronous digital connection.

Another method, consistent with certain embodiments of the present invention, of transmitting images from a television set-top box to a digital television, comprises at the television set-top box: determining if a digital bitmap image is larger in size than a threshold and if the digital bitmap image is larger is size than the threshold: converting the digital bitmap image to an analog image; sending a control message as an audio video control (AVC) command to the digital television to switch from a digital input to an analog input to receive the analog image; sending the analog image to the digital television; and if the digital bitmap image is not larger is size than the threshold: sending the digital images using EIA775a protocol over an IEEE 1394 digital connection.

A producer device consistent with certain embodiments of the present invention has a circuit that receives digital content containing a bitmap image. A processor determines a size of the bitmap image. The bitmap image is converted to an analog representation in the event the size of the bitmap image exceeds a threshold. A digital output circuit sends digital information to a consumer device. An analog output circuit sends the analog representation to the consumer device.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a conceptual block diagram of a producer device and a consumer device consistent with certain embodiments of the present invention.

FIG. 2 is a flow chart depicting a process for switching between digital and analog signal paths for efficiently handling large bitmap data consistent with certain embodiments of the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

Whenever large amounts of data are transmitted using EIA775A, performance can be poor. This is due in part to the large amount of data associated with an uncompressed bitmap image, but it is also related to the EIA775A protocol's overhead requirements along with the overhead requirements of IEEE 1394 communications, along with the speed limitation of IEEE 1394. The present invention seeks to improve performance in a large bitmap image scenario by utilizing an analog signal path to transmit analog images rather than digital bitmap images when the bitmap image size exceeds a threshold. An appropriate threshold, can be readily determined experimentally, for example, to be a bitmap size that results in noticeable delays in display of the digital image. However, this is not to be considered limiting since other systems may deviate from this particular threshold without departing from the present invention.

An example of the type of scenario wherein transfer of large bitmap images can produce poor performance is in the case where on-screen data (OSD) representing a program guide is being delivered from a television set-top box to a digital television. In this situation, the OSD can represent a large bitmap image which transfers very slowly between the set-top box and the digital television, and thus creates a scenario wherein the user must endure delays awaiting completion of the data transfer.

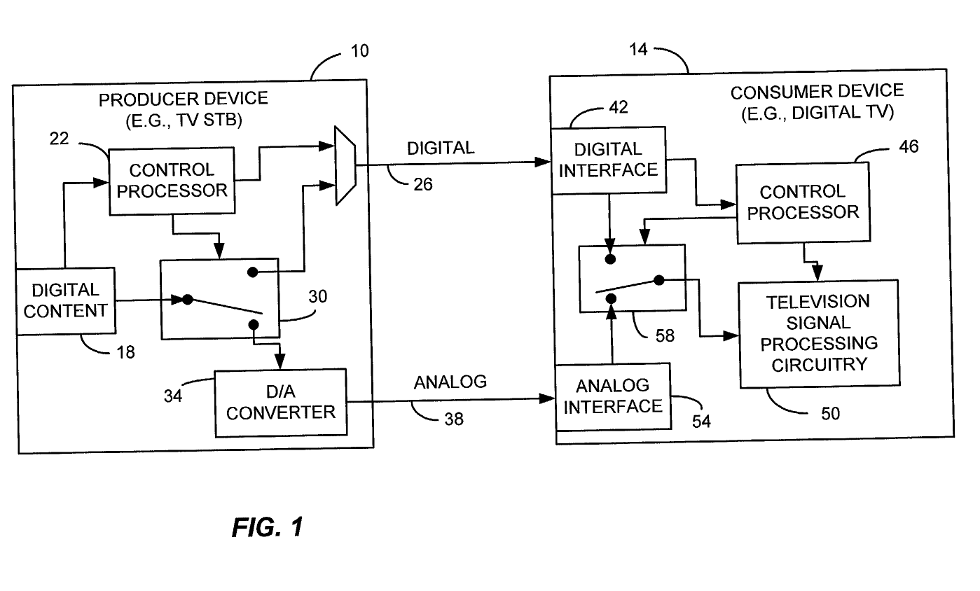

FIG. 1 depicts broadly a producer device 10 communicating via both digital and analog signal paths with a consumer device 14. As previously described, producer device 10 may represent, for example, a television set-top box while consumer device 14 may represent, for example, a digital television. For purposes of this example, it is assumed that producer device 10 receives or contains content which is in digital form illustrated by digital content 18. This content is analyzed by a control processor 22 which makes a determination as to whether or not a large bitmap image is to be transmitted over a digital interface 26. If a large bitmap image is to be transmitted, the control processor switches, using switch 30, the digital content from 18 through a digital-to-analog converter 34 and transmits analog content over an analog interface 38 (of course, the analog content is overlaid on a conventional analog television protocol such as, for example, PAL or NTSC). In addition, control processor 22 sends a message over digital connection 26 to the consumer device 14 to instruct the consumer device to switch to an analog input for receipt of the signal.

At consumer device 14, the digital connection 26 passes data to a digital interface 42 and then on to switch 58, where switch 58 is operated under control of a control processor 46, before passing the digital signal to television signal processing circuitry 50 for display on a television display (assuming that the consumer device 14 is a digital television.) Similarly, analog signals through analog connection 38 pass through an analog interface 54 and then on through switch 58 to the television signal processing circuitry. Depending upon the position of switch 58, which is operated under control of control processor 46 based upon signals received via the digital interface 42 and passed on to control processor 46, either the digital image from digital connection 26 and digital interface 42 passes to the television signal processing circuitry 50 or the analog signal from analog interface 54 passes through switch 58 to television signal processing circuitry 50. Switch 58 operates under the control of control processor 46 based upon messages received from producer device 10 instructing the control processor to accept input as either analog or digital.

Of course, those skilled in the art will recognize that the present invention as depicted in FIG. 1 is illustrative of the concept used to transmit large bitmap images as analog signals and is not necessarily directly correlated with hardware or software present within the consumer or producer devices. Those skilled in the art will understand how to adapt the various designs of producer devices to effect the operation described herein.

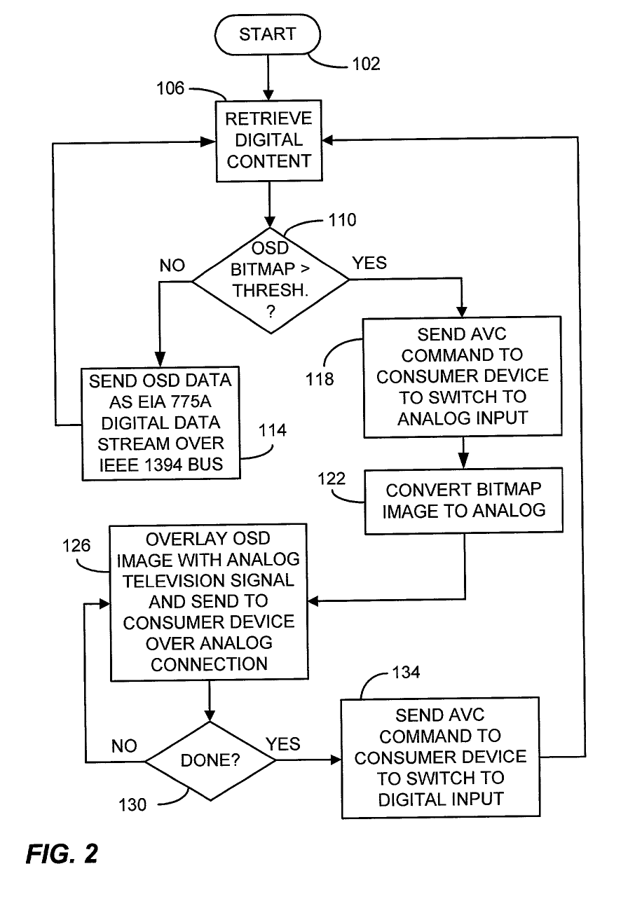

FIG. 2 depicts a process 100 starting at 102 for implementing an embodiment of the present invention, for example, in software within a microprocessor or micro-controller device. At 106, digital content is retrieved or received from a source of such content (e.g., a cable system, a satellite system, or a storage device such as a disk drive or memory). The content is analyzed at 110 to determine if an OSD bitmap image is to be displayed which exceeds a threshold in size. If not, the OSD data is transmitted to the DTV over the IEEE1394 bus ussing the EIA 775a protocol and are mixed with the decoded MPEG viedo in the DTV prior to being presented to the display. Control then returns to 106 to retrieve or receive the next segment of digital content.

If, on the other hand, the OSD bitmap data exceeds the predetermined threshold at 110, control passes to 118 where an audio/video control (AVC) command is sent from the producer device to the consumer device instructing the consumer device to switch from its digital input to its analog input. The bitmap image is then converted to analog at 122 and the analog OSD image is overlaid with the analog signal stream and sent to the consumer device over the analog connection at 126. Once the image has been completely transmitted and there is no further large bitmap data to be transmitted as analog at 130, an audio video control command is sent at 134 to the consumer device instructing the consumer device to switch back to the digital input and control returns to 106.

In this manner large bitmap images which would normally degrade system performance can be efficiently transmitted as analog and substantially enhance performance. The above technique is particularly useful to display information such as graphical user interface information, program guides and the like using NTSC or PAL analog video for delivery and display via an analog communication path on digital television.

Those skilled in the art will recognize that the present invention has been described in terms of exemplary embodiments based upon use of a programmed processor such as control processors 22 and 46. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps and associated data used to implement the embodiments described above can be implemented using disc storage as well as other forms of storage such as for example Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention, as described in embodiments herein, is implemented using a programmed processor executing programming instructions that are broadly described above in flow chart form that can be stored on any suitable electronic storage medium or transmitted over any suitable electronic communication medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A method of transmitting images from a producer device to a consumer device, comprising at the producer device:
determining that a digital bitmap image is larger in size than a threshold;
converting the digital bitmap image to an analog image; and
sending the analog image to the consumer device.

2. The method according to claim 1, further comprising sending a control message to the consumer device to switch from a digital input to an analog input to receive the analog image.

3. The method according to claim 2, further comprising sending a control message to the consumer device to switch from the analog input back to the digital input to receive digital images after the analog image has been sent.

4. The method according to claim 2, wherein the digital input comprises an IEEE 1394 digital input.

5. The method according to claim 2, wherein the control message comprises an audio video control (AVC) command.

6. The method according to claim 3, wherein the control messages comprise audio video control (AVC) commands.

7. The method according to claim 1, wherein the digital bitmap image comprises a graphical user interface (GUI) image.

8. The method according to claim 1, wherein the digital bitmap image comprises a television program guide image.

9. The method according to claim 1, wherein the consumer device comprises a digital television.

10. The method according to claim 1, wherein the producer device comprises a television set-top box.

11. The method according to claim 1, further comprising sending digital bitmap images to a digital input in the consumer device when the digital bitmap images are smaller than the threshold.

12. The method according to claim 11, wherein the digital images are sent using EIA775a protocol over an IEEE 1394 digital connection.

13. The method according to claim 1, wherein the analog image is sent as one of an NTSC and PAL format analog image.

14. An electronic storage medium storing instructions which, when executed on a programmed processor, carry out method according to claim 1.

15. A method of transmitting images from a producer device to a consumer device, comprising at the producer device:
determining if a digital bitmap image is larger in size than a threshold and if the digital bitmap image is larger is size than the threshold:
converting the digital bitmap image to an analog image;
sending a control message as an audio video control (AVC) command to the consumer device to switch from a digital input to an analog input to receive the analog image;
sending the analog image to the consumer device as an overlay on an analog television signal; and
if the digital bitmap image is not larger is size than the threshold:
sending the digital images using EIA775a protocol over an IEEE 1394 digital connection.

16. The method according to claim 15, further comprising sending a control message to the consumer device to switch from the analog input back to the digital input to receive digital images after the analog image has been sent.

17. The method according to claim 15, wherein the digital bitmap image comprises a graphical user interface (GUI) image.

18. The method according to claim 15, wherein the digital bitmap image comprises a television program guide image.

19. The method according to claim 15, wherein the consumer device comprises a digital television.

20. The method according to claim 15, wherein the producer device comprises a television set-top box.

21. The method according to claim 15, wherein the analog image is sent as one of an NTSC and PAL format analog image.

22. An electronic storage medium storing instructions which, when executed on a programmed processor, carry out method according to claim 15.

23. A method of transmitting images from a television set-top box to a digital television, comprising at the television set-top box:
determining if a digital bitmap image is larger in size than a threshold and if the digital bitmap image is larger is size than the threshold:
converting the digital bitmap image to an analog image;
sending a control message as an audio video control (AVC) command to the digital television to switch from a digital input to an analog input to receive the analog image;
sending the analog image to the digital television; and
if the digital bitmap image is not larger is size than the threshold:
sending the digital images using EIA775a protocol over an IEEE 1394 digital connection.

24. The method according to claim 23, wherein the digital bitmap image comprises one of a graphical user interface (GUI) image and a television program guide image.

25. The method according to claim 23, wherein the analog image is sent as one of an NTSC and PAL format analog image.

26. A producer device, comprising:
means for receiving digital content containing a bitmap image;
means for determining a size of the bitmap image;
means for converting the bitmap image to an analog representation in the event the size of the bitmap image exceeds a threshold;
a digital output circuit for sending digital information to a consumer device; and
an analog output circuit for sending the analog representation to the consumer device.

27. The apparatus according to claim 26, further comprising means for sending a control message to the consumer device to switch from a digital input to an analog input to receive the analog image.

28. The apparatus according to claim 26, wherein the digital output circuit comprises an IEEE 1394 digital interface.

29. The apparatus according to claim 26, wherein the control message comprises an audio video control (AVC) command.

30. The apparatus according to claim 26, wherein the digital bitmap image comprises one of a graphical user interface (GUI) image and a television program guide image.

31. The apparatus according to claim 26, wherein the consumer device comprises a digital television.

32. The apparatus according to claim 26, wherein the producer device comprises a television set-top box.

33. The apparatus according to claim 26, further comprising sending digital bitmap images to a digital input in the consumer device when the digital bitmap images are smaller than the threshold.

34. The apparatus according to claim 33, wherein the digital images are sent using EIA775a protocol over an IEEE 1394 digital connection.

35. The apparatus according to claim 26, wherein the analog image is sent as one of an NTSC and PAL format analog image.

36. The apparatus according to claim 26, wherein the means for determining the size comprises a programmed processor.
